(19) United States
(12) Patent Application Publication
(10) Pub. No.: US 2022/0289948 A1
(43) Pub. Date: Sep. 15, 2022

(54) COMPOSITION OF CELLULOSE NANOCRYSTALS AND CARBOXYMETHYL CELLULOSE

(71) Applicants: Purdue Research Foundation, West Lafayette, IN (US); United States Department of Agriculture, Washington, DC (US)

(72) Inventors: Jeffrey Paul Youngblood, Crawfordsville, IN (US); Sami Miguel El Awad Azrak, Midland, MI (US); Robert John Moon, Marietta, GA (US); Gregory T. Schueneman, Madison, WI (US)

(73) Assignee: Purdue Research Foundation, West Lafayette, IN (US)

(21) Appl. No.: 17/695,443

(22) Filed: Mar. 15, 2022

Related U.S. Application Data
(60) Provisional application No. 63/160,956, filed on Mar. 15, 2021.

(51) Int. Cl. C08L 1/28

(52) U.S. Cl. CPC C08L 1/286; C08L 2205/025

(57) ABSTRACT

A substantially homogeneous composition comprising cellulose nanocrystals (CNC) and carboxymethyl cellulose (CMC), wherein said CNC and CMC provide 85-95% of and 5-15% of total dry weight percentage of said CNC and CMC, respectively; a method of preparing a dried composition comprising CNC and CMC, and re-dispersing said dried composition into water to form a substantially homogeneous aqueous suspension without visible precipitate.

### CROSS-REFERENCE TO RELATED APPLICATIONS

This application claims priority to U.S. Provisional Patent application No. 63/160,956, which was filed Mar. 15, 2021, and which is incorporated by reference herein its entirety.

### TECHNICAL FIELD

The present disclosure provides a substantially homogeneous composition comprising cellulose nanocrystals (CNC) and carboxymethyl cellulose (CMC), and a method of making and using the substantially homogeneous composition.

### BACKGROUND

This section introduces aspects that may help facilitate a better understanding of the disclosure. Accordingly, these statements are to be read in this light and are not to be understood as admissions about what is or is not prior art.

Cellulose nanomaterials (CNMs) like that of cellulose nanocrystals (CNCs) are sustainable, biodegradable, and highly abundant in nature as they can be sourced from wood, plants, algae, and even bacteria. Industrially, CNCs have found uses in many different applications including, cosmetics, composites, paints, inks, gas, packaging, construction, food, to name just a few. Morphologically, CNCs isolated through acid hydrolysis are short (50-500 nm long and 3-20 nm wide) and highly crystalline rods (crystalline contents of up to 88% depending on the source). Additionally, depending on the type of acid used for hydrolysis, different functional surface groups are possible. For example, hydrolysis with H₂SO₄, H₃PO₄, HCl+TEMPO oxidation, or HCl lead to the formation of negatively charged sulfate half esters (SO₄-CNC), phosphate half esters (PO₄-CNC), carboxylic acids (COOH-CNC), and neutral hydroxyls (OH-CNC), respectively. After isolation, CNCs are typically spray dried (SD) or freeze dried (FD) into a powder form which significantly reduces transportation costs due to removal of water (at least an ˜80% reduction in weight) and improves handling and feeding during processing into other materials. That said, both SD and FD have been reported to cause drastic aggregation of the nanoparticles, especially for neutrally charged CNCs (i.e., OH-CNC). For example, CNCs have been reported to form spherical and flake like agglomerates which reduces their properties and performance.

Therefore, there is a need for reducing agglomeration of CNCs during drying or improving their redispersion after drying will to eliminate or reduce the need to carry out high energy intensive mixing processes to achieve near pre-dried conditions and take full advantage of the original properties.

### SUMMARY

The present disclosure provides a substantially homogeneous composition comprising cellulose nanocrystals (CNC) and carboxymethyl cellulose (CMC), and a method of making and using the substantially homogeneous composition.

In one embodiment, provided is a substantially homogeneous composition, wherein the composition is in a dried form and consists essentially of CNC and CMC, and the said composition can be re-dispersed into water to form a substantially homogeneous aqueous suspension without visible precipitate.

In one embodiment, provided is a substantially homogeneous composition comprising CNC and CMC, wherein said CNC and CMC provides 85-95% of and 5-15% of total dry weight percentage of said CNC and CMC, respectively. The present disclosure further provides the substantially homogeneous composition wherein said CNC and CMC provides 85-90% of and 10-15% of total dry weight percentage of said CNC and CMC, respectively.

In one embodiment, provided is a substantially homogeneous composition comprising CNC and CMC, wherein said CMC comprises carboxymethyl cellulose sodium salt.

In one embodiment, provided is a method of preparing a dried composition comprising CNC and CMC and re-dispersing said dried composition into water to form a substantially homogeneous aqueous suspension without visible precipitate.

In one embodiment, provided is a method of preparing a dried composition comprising CNC and CMC and re-dispersing said dried composition into water to form a substantially homogeneous aqueous suspension without visible precipitate, wherein the method is carried out below 100° C. and comprises,
providing an aqueous suspension of CNC;
providing an aqueous solution of CMC;
mixing said aqueous suspension of CNC and said aqueous solution of CMC to form a substantially homogeneous aqueous suspension of CNC and CMC;
drying said homogeneous aqueous suspension of CNC and CMC to provide a dried composition of CNC and CMC; and
adding water to said dried composition of CNC and CMC to form a substantially homogeneous aqueous suspension of CNC and CMC without visible precipitate.
wherein said CNC and CMC provides 85-95% of and 5-15% of total dry weight percentage of said CNC and CMC, respectively.

### BRIEF DESCRIPTION OF THE DRAWINGS

FIG. 1 illustrates partially dried CNC+CMC mixture with a 10% CMC loading (A), fully dried CNC+CMC films with different CMC loadings (10% (B), 5% (E), 2% (F), and 1% (G)), partially dried pure CNC suspension (C), and fully dried pure CNC film (D), all in a polystyrene petri dish.

FIG. 2 illustrates rehydrated CNC+CMC (A) and 24 hours re-dispersed CNC+CMC both with a 10% CMC loading (B), rehydrated pure CNC (C) and 24 hours re-dispersed pure CNC (D), never dried pure CNC suspension (E), and 24 hours re-dispersed CNC+CMC with a 5% (F), 2% (G), and 1% (H) CMC loading.

FIG. 3 illustrates hydrodynamic size versus CMC loading (%) with respect to CNC (dry weight). The grey point represents dried CNC which was re-dispersed in water and sonicated (1000 J/g CNC) while the black point represents never dried CNC which was just mechanically stirred.

### DETAILED DESCRIPTION

For the purposes of promoting an understanding of the principles of the present disclosure, reference will now be made to embodiments illustrated in drawings, and specific language will be used to describe the same. It will nevertheless be understood that no limitation of the scope of this disclosure is thereby intended.

The term “about” can allow for a degree of variability in a value or range, for example, within 10%, within 5%, or within 1% of a stated value or of a stated limit of a range.

The term “substantially” can allow for a degree of variability in a value or range, for example, within 90%, within 95%, or within 99% of a stated value or of a stated limit of a range.

Provided is a substantially homogeneous composition comprising cellulose nanocrystals (CNC) and carboxymethyl cellulose (CMC), and a method of making and using the substantially homogeneous composition that overcomes the problem of agglomeration of CNCs during drying and improving their redispersion after drying to eliminate or reduce the need to carry out high energy intensive mixing processes to achieve near pre-dried conditions and take full advantage of the original properties.

CMC is used as a dispersant in the said composition as it provides lower viscosity of the cellulose nanomaterials (CNMs) in aqueous suspension than other competing dispersants such as methyl cellulose, hydroxymethylcellulose, hydroxyethylcellulose, guar gum, konjac glucomannan, amphoteric starch, cationic starch, poly(ethylene imine), polyacrylic acid sodium salt, carrageenan, carbopol, tragacanth gum, xanthan gum and anionic polyacrylamide.

CMC in incorporated into acid-hydrolyzed CNCs by mixing, such as by simple shear mixing. A small CMC concentration of 0.1 to 1 (CMC to CNC, dry weight) was added to the CNCs in a liquid form. CMC+CNC solutions were dried at ambient conditions and re-dispersed in water by simple mechanical stirring. Zeta potential and size were used to characterize the redispersion behavior. Additionally, low energy (1000 J/g CNC) sonication was also used and its effect on redispersion was assessed.

In one embodiment, provided is a substantially homogeneous composition comprising CNC and CMC, wherein said CNC and CMC provides 85-95% of and 5-15% of total dry weight percentage of said CNC and CMC, respectively.

In one embodiment of the substantially homogeneous composition comprising CNC and CMC, the composition is in a dried form and consists essentially of said CNC and CMC, and the composition can be re-dispersed into water to form a substantially homogeneous aqueous suspension without visible precipitate.

In one embodiment of the substantially homogeneous composition comprising CNC and CMC, the CNC and CMC provide 85-90% of and 10-15% of total dry weight percentage of said CNC and CMC, respectively.

In one embodiment of the substantially homogeneous composition comprising CNC and CMC, the CMC comprises carboxymethyl cellulose sodium salt.

In one embodiment provided is a method of preparing a dried composition comprising CNC and CMC and re-dispersing said dried composition into water to form a substantially homogeneous aqueous suspension without visible precipitate, wherein the method comprises:

providing an aqueous suspension of CNC;

providing an aqueous solution of CMC;

mixing said aqueous suspension of CNC and said aqueous solution of CMC to form a substantially homogeneous aqueous suspension of CNC and CMC;

drying said homogeneous aqueous suspension of CNC and CMC to provide a dried composition of CNC and CMC; and

adding water to said dried composition of CNC and CMC to form a substantially homogeneous aqueous suspension of CNC and CMC without visible precipitate,

wherein said CNC and CMC provides 85-95% of and 5-15% of total dry weight percentage of said CNC and CMC, respectively.

In one embodiment of the method of preparing a dried composition comprising CNC and CMC and re-dispersing said dried composition into water to form a substantially homogeneous aqueous suspension without visible precipitate, the CNC and CMC provide 85-90% of and 10-15% of total dry weight percentage of said CNC and CMC, respectively.

In one embodiment of the method of preparing a dried composition comprising CNC and CMC and re-dispersing said dried composition into water to form a substantially homogeneous aqueous suspension without visible precipitate, the CMC comprises carboxymethyl cellulose sodium salt.

In one embodiment, the dried composition comprising CNC and CMC is prepared below 100° C., 75° C., 50° C., or 25° C. In one aspect, the dried composition comprising CNC and CMC is prepared between 0-100° C., 25-100° C., 50-100° C., 25-75° C., 25-50° C.

### Experimental Section

### Materials

A suspension of cellulose nanocrystals with a solids concentration of 8.1 wt. % was kindly supplied by Blue Goose Biorefineries Inc. Per supplier information, the CNCs were produced through a proprietary transition metal catalyzed oxidative process. The CNCs had a hydrodynamic size of ˜140 nm with no sulfate half ester moieties and a carboxyl content of 150 mmol/kg. Carboxymethyl cellulose sodium salt powder (Mw=250,000, degree of substitution=0.7, Lot #MKCK7917) was procured from Sigma Aldrich. De-ionized water was produced using a Barnstead system and used for all experiments.

### Preparation of CNC and CNC+CMC Suspensions

The initial ˜8 wt. % CNC suspension was diluted to ˜4 wt. % by using a SpeedMixer™ (Flacktek Inc.) system at 2500 rpm for 5 minutes. Subsequently, a 2% (w/v) CMC solution was prepared by mechanical stirring at 40° C. for roughly 40 minutes. The CNC suspension and the CMC solution were combined to achieve a dry weight ratio of CMC to CNC of 0.1 to 1, 0.05 to 1, 0.02 to 1, and 0.01 to 1 (i.e., 10%, 5%, 2%, and 1% CMC loading with respect to CNC). The CNC+CMC mixture was then mixed for 5 minutes at 2500 rpm. Subsequently, 40 ml of the CNC+CMC mixture was then cast into polystyrene petri dishes and left to dry at ambient conditions for roughly 2 weeks. Samples of pure CNC with no CMC were also prepared and left to dry. Lastly, a never dried pure CNC suspension and a CNC+CMC mixtures were also stored and used as control groups for the dried and re-dispersed suspensions.

### Redispersion of CNC+CMC

Once dried, the CNC+CMC and pure CNC films were delaminated from the petri dish and broken down into smaller pieces by hand and by using a mortar and pestle. Approximately 0.28 grams of dry CNC+CMC or pure CNC was placed into a scintillation vile followed by 14 ml of water in order to achieve a target concentration of 2 wt. % and stirred for 24 hours at 25° C. Subsequently, the mixtures were diluted to 0.025 wt. % with DI water and stirred for an additional 20 minutes for testing. Additionally, a 1 wt. % mixture (from the original 2 wt. %) was sonicated with a total input of 1000 J/g of CNC and then further dilute to 0.025 wt. % for testing.

### Characterization of CNC+CMC

Mechanically stirred, sonicated, and never dried samples with a solids concentration of 0.025 wt. % were assessed for each group (pure CNC and CNC+CMC) using a Zetasizer Nano ZS (Malvern Panalytical) and disposable folded capillary cells (DTS1070).

### Results and Discussion

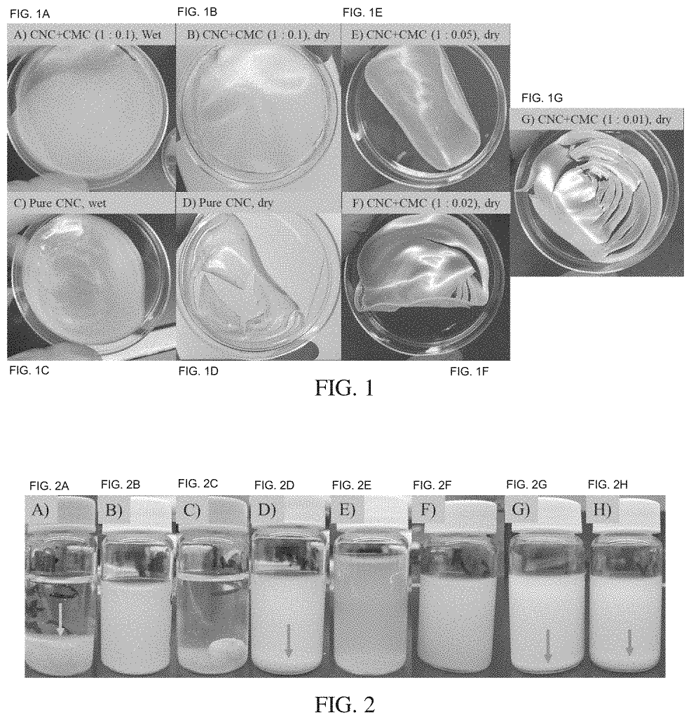

In the partially wet state, the addition of CMC into CNC lead to the suppression of the irradiance observed for a pure CNC (see FIG. 1A verses FIG. 1C). It was also observed that CMC improves the film forming properties of CNC as wrinkles and warping is significantly suppressed for the dry films (see FIG. 1B verses FIG. 1D). As observed, as the CMC loading decreased the dry films started warping and developing cracks and looked more like the pure CNC film (FIG. 1E, FIG. 1F, and FIG. 1G).

As observed in FIG. 2A, once the dry CNC+CMC film (10% CMC loading) is broken down into smaller pieces and water in added there is an immediate rehydration as pointed by the white arrow. This is not the case for dried pure CNC, where there is no perceivable rehydration as shown in FIG. 2C, hence the stirring bar inside the vile is clearly visible. After mechanical stirring for 24 hours, CNC+CMC (10% CMC loading) was completely re-dispersed and no pieces sedimented in the bottom (FIG. 2B). This also occurred for CNC+CMC with a CMC loading of 5% (FIG. 2F). In contrast, dried pure CNC did not re-disperse, and significant sedimentation was present as point out by the grey arrow (FIG. 2D). Sedimentation was also present for dried CNC+CMC with a 1% and 2% CMC loading as shown in FIG. 2G and FIG. 2H by the grey arrows, respectively. It is important to point out that re-dispersed CNC+CMC suspensions (10% and 5% CMC loading) did appear to be slightly hazy compared to a never dried pure CNC suspension (FIG. 2B and FIG. 2F versus FIG. 2E). This was later attributed to some CNC aggregation due to the CMC.

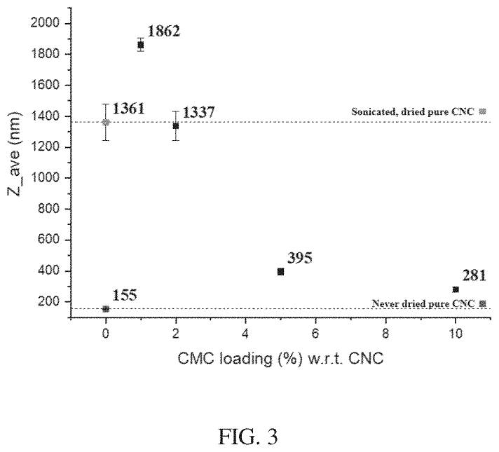

Zeta potential and hydrodynamic size results are summarized and shown in Table 1 below. In the never dried state, the results show that the addition of CMC causes a slight aggregation of the CNC nanoparticles (Zₐᵥₑ˜154 nm for pure CNC verses ˜233 nm for CNC+CMC with a CMC loading of 10%). That said, after drying and subsequent 24-hour mechanical stirring, CMC allowed for significant redispersion of CNC (Zₐᵥₑ˜2500 nm for pure CNC verses ˜475 nm for CNC+CMC with a CMC loading of 10%). As expected, when sonication was used (1000 J/g of CNC) redispersion was further improved in both pure CNC and CNC+CMC systems. For example, Zₐᵥₑ˜1361 nm for pure CNC verses ˜281 nm for CNC+CMC with a CMC loading of 10%. It is important to note that redispersion of dry CNC+CMC through sonication reached an almost pre-dried hydrodynamic size (Zₐᵥₑ˜233 nm for never dried CNC+CMC verses ˜281 nm for sonicated CNC+CMC with a CMC loading of 10%). There is also a clear trend with regards to zeta potential where the net surface charge was increased from approximately −40 mV for pure CNC to −60 mV for CNC+CMC, regardless of the redispersion method used or state (i.e., never dried verses re-dispersed). This is possibly attributed to the adsorption of CMC onto the CNC surfaces which improves suspension stability. Additionally, as the CMC loading was decreased the hydrodynamic size increased. For example, a CMC loading of 5% lead to a Zₐᵥₑ of 395±21 nm after sonication which represents a ˜41% increase in size (i.e., lower redispersion) when compared to CNC+CMC with a CMC loading of 10%. It was found that for CNC+CMC with CMC loadings of 2% and 1%, that the Zₐᵥₑ was equivalent (Zₐᵥₑ=1337±96 nm for 2%, and Zₐᵥₑ=1862±43 nm) to having pure CNC (Zₐᵥₑ=1361±116 nm). Thus, a critical CMC loading between 5% and 15% is required to achieve a reasonable level of CNC redispersion. Some of the results from Table 1 are represented in a scatter plot in FIG. 3 for easier visualization.

TABLE 1
Zeta potential and hydrodynamic size (Zₐᵥₑ) results. For zeta potential 9
measurements were collected for each sample while for size 5 measurements per sample were
collected. The average and the standard deviation are shown.

| | | CMC | Zeta Potential | |
|---|---|---|---|---|
| Redispersion Method | System | loading | [mV] | Z_ave [nm] |
| Never Dried | CNC | 0% | −40 ± 0.99 | 155 ± 2 |
| Never Dried + Sonication | CNC | 0% | −40 ± 1.61 | 126 ± 1 |
| Stirring | CNC | 0% | −38.8 ± 0.77 | 2456 ± 192 |
| Sonication | CNC | 0% | −36.9 ± 1.09 | 1361 ± 116 |
| Never Dried | CNC + CMC | 10% | −59.9 ± 1.83 | 233 ± 5 |
| Never Dried + Sonication | CNC + CMC | 10% | −54.6 ± 3.41 | 173 ± 2 |
| Stirring | CNC + CMC | 10% | −65.7 ± 2.07 | 475 ± 100 |
| Sonication | CNC + CMC | 10% | −59.1 ± 2.96 | 281 ± 17 |
| Stirring | CNC + CMC | 5% | −63.0 ± 0.76 | 645 ± 26 |
| Sonication | CNC + CMC | 5% | −60.0 ± 1.06 | 395 ± 21 |
| Stirring | CNC + CMC | 2% | −55.1 ± 1.40 | 5569 ± 301 |
| Sonication | CNC + CMC | 2% | −53.1 ± 1.09 | 1337 ± 96 |
| Stirring | CNC + CMC | 1% | −44.4 ± 2.24 | 6120 ± 747 |
| Sonication | CNC + CMC | 1% | −48.1 ± 0.78 | 1862 ± 43 |

Overall, the results of the present disclosure show that small concentrations of CMC (such as 0.1 to 1 or 0.05 to 1, CMC to CNC) can be easily incorporated into hydrolyzed CNC by shear mixing. The addition of CMC drastically improved the redispersion behavior and suppressed aggregation without using energy intensive mixing techniques (i.e., only mechanical stirring or sonication). More broadly, the results show that CNC+CMC systems can be easily dried at ambient conditions and transported for processing, significantly reducing transportation costs and can be used in various applications including paper and paperboard, food packaging, construction, cosmetics, composites, paints, inks, gas, and packaging to name just a few.

We claim:

1. A substantially homogeneous composition comprising cellulose nanocrystals (CNC) and carboxymethyl cellulose (CMC), wherein said CNC and CMC provides 85-95% of and 5-15% of total dry weight percentage of said CNC and CMC, respectively.

2. The substantially homogeneous composition of claim 1, wherein the composition is in a dried form and consists essentially of said CNC and CMC, and wherein the composition can be re-dispersed into water to form a substantially homogeneous aqueous suspension without visible precipitate.

3. The substantially homogeneous composition of claim 1, wherein said CNC and CMC provides 85-90% of and 10-15% of total dry weight percentage of said CNC and CMC, respectively.

4. The substantially homogeneous composition of claim 1, wherein said CMC comprises carboxymethyl cellulose sodium salt.

5. A method of preparing substantially homogeneous composition comprising cellulose nanocrystals (CNC) and carboxymethyl cellulose (CMC), by preparing a dried composition of said CNC and CMC followed by re-dispersing the said dried composition into water to form a substantially homogeneous aqueous suspension without visible precipitate.

6. The method of claim 5, comprises the steps of:
providing an aqueous suspension of cellulose nanocrystals (CNC);
providing an aqueous solution of carboxymethyl cellulose (CMC);
mixing said aqueous suspension of CNC and said aqueous solution of CMC to form a substantially homogeneous aqueous suspension of CNC and CMC;
drying said homogeneous aqueous suspension of CNC and CMC to provide a dried composition of CNC and CMC; and
adding water to said dried composition of CNC and CMC to form a substantially homogeneous aqueous suspension of CNC and CMC without visible precipitate,
wherein said CNC and CMC provides 85-95% of and 5-15% of total dry weight percentage of said CNC and CMC, respectively.

7. The method of claim 6, wherein said CNC and CMC provides 85-90% of and 10-15% of total dry weight percentage of said CNC and CMC, respectively.

8. The method of claim 6, wherein said CMC comprises carboxymethyl cellulose sodium salt.

9. The method of claim 6, wherein the method is carried out below 100° C.
